(19) United States
(12) Patent Application Publication
(10) Pub. No.: US 2018/0157310 A1
(43) Pub. Date: Jun. 7, 2018

(54) METHOD FOR ANALYZING CLIENT EVENTS OF ELECTRIC POWER CONSUMER

(71) Applicant: INSTITUTE FOR INFORMATION INDUSTRY, Taipei City (TW)

(72) Inventors: CHIA-WEI TSAI, TAINAN CITY (TW); CHUN-WEI YANG, MAGONG CITY (TW); YUNG-CHIEH HUNG, TAIPEI CITY (TW)

(21) Appl. No.: 15/370,356

(22) Filed: Dec. 6, 2016

(30) Foreign Application Priority Data
Dec. 1, 2016 (TW) 105139636

(51) Int. Cl. G06F 1/32

(52) U.S. Cl. CPC G06F 1/3287

(57) ABSTRACT

The present invention provides a method for analyzing client events of an electric power consumer. By using the load operation time of the loads of the electric power consumer, the load operation modes can be given. By relating the load operation modes, the load operation relation modes will be given. Then data mining or an expert system can be adopted for corresponding the load operation modes to the client events and thus giving the behavior model of the electric power consumer.

### FIELD OF THE INVENTION

The present invention relates generally to a method for client events, and particularly to a method for analyzing client events of an electric power consumer according to the load operating conditions of the electric power consumer.

### BACKGROUND OF THE INVENTION

As technologies progress, each electric power consumer owns a substantial amount of loads, for example, air conditioners, refrigerators, electric heaters, dehumidifying dryers, exhaust fans, TVs, video games, computers, microwave ovens, or electromagnetic ovens. When a family member is at home, more or less these loads will be used. As these loads are turned on, the electric meter starts to operate and record the power consumption of the electric power consumer. Thereby, the electric power company can charge the electric power consumer.

Currently, there are two main ways to acquire the load operation conditions of electric power consumers: invasive and noninvasive load detection. When the invasive load detection method is adopted to acquire the load operation conditions of electric power consumers, each load of the electric power consumers will be connected to a measurement unit. As the load operates, the measurement unit connected to the load will sense the operation of the load. As the load stops operating, the measurement unit connected to the load will sense as well. Thereby, the load operation time, the load startup time, and the load shutdown time can be acquired.

When the noninvasive load detection method is adopted for acquiring the load operation conditions of electric power consumers, a smart meter is used for acquiring the total power consumption of an electric power consumer during a period. In addition, an algorithm is used to compare the total power consumption according to the power-consuming feature of each load and give the load operation condition of each load.

Whether the loads of an electric power consumer operate depends strongly on the behaviors thereof. Nonetheless, the current load operation of an electric power consumer is mostly used on detecting the load operation condition of the electric power consumer; there is no application of relating whether the loads operate to the behavior of the electric power consumer.

### SUMMARY

An objective of the present invention is to provide a method for analyzing client events of an electric power consumer. By using the load operation mode of the loads of the electric power consumer, the load operation relation mode can be acquired. Besides, client events of the electric power consumer are enabled to correspond to the load operation relation mode to give the behavior mode of the electric power consumer.

In order to achieve the above objective and efficacy, according to an embodiment of the present invention, a method for analyzing client events of an electric power consumer is disclosed. The method comprises steps of: acquiring a plurality pieces of load information of the electric power consumer and defining one or more client event; acquiring a plurality of load operation modes of the electric power consumer according to the respective load operation time of the plurality pieces of load information; acquiring a plurality of load operation relation modes according to the plurality of load operation modes; and corresponding the plurality of load operation relation modes to the one or more client event, respectively.

According to an embodiment of the present invention, after the step of acquiring the plurality of load operation modes of the electric power consumer according to the respective load operation time of the plurality pieces of load information, the method further comprises a step of calculating the frequency of each load in each load operation mode using a support algorithm and giving the plurality of load operation modes.

According to an embodiment of the present invention, after the step of acquiring the plurality of load operation modes of the electric power consumer according to the respective load operation time of the plurality pieces of load information, the method further comprises a step of calculating to give the plurality of load operation modes according to a piece of location information of each piece of load information or/and a piece of type information of each piece of load information in each load operation mode using a similarity algorithm.

According to an embodiment of the present invention, after the step of acquiring the plurality of load operation modes of the electric power consumer according to the respective load operation time of the plurality pieces of load information, the method further comprises a step of calculating to give the plurality of load operation modes using a support algorithm, a similarity algorithm, and each load operation mode.

According to an embodiment of the present invention, the plurality of load operation relation modes are acquired by calculating the probability density function.

According to an embodiment of the present invention, the plurality of load operation relation modes correspond to the one or more client event by an expert system or data mining.

According to an embodiment of the present invention, the load operation time includes the load startup time and the load shutdown time.

### BRIEF DESCRIPTION OF THE DRAWINGS

FIG. 1 shows a flowchart of the method for analyzing client events of an electric power consumer according to the first embodiment of the present invention;

FIG. 2 shows a system schematic diagram of the method for analyzing client events of an electric power consumer according to the first embodiment of the present invention:

FIG. 3 shows a system schematic diagram of the method for analyzing client events of an electric power consumer according to the second embodiment of the present invention; and

FIG. 4 shows a system schematic diagram of the method for analyzing client events of an electric power consumer according to the third embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

According to the prior art, there is no application of relating whether the loads operate to the behavior of the electric power consumer. Thereby, the present invention provides a method for analyzing client events of an electric power consumer according to the load operation conditions of the electric power consumer.

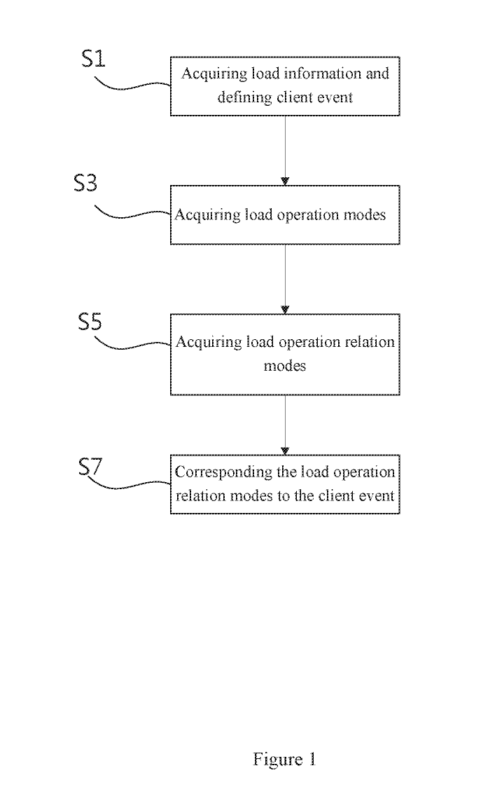

Here, the flow of the method for analyzing client events of an electric power consumer according to the first embodiment of the present invention will be described. Please refer to FIG. 1, which shows a flowchart of the method for analyzing client events of an electric power consumer according to the first embodiment of the present invention. As shown in the figure, the method for analyzing client events of an electric power consumer according to the present embodiment comprises steps of:

Step S1: Acquiring load information and defining client event;
Step S3: Acquiring load operation modes;
Step S5: Acquiring load operation relation modes; and
Step S7: Corresponding the load operation relation modes to the client event.

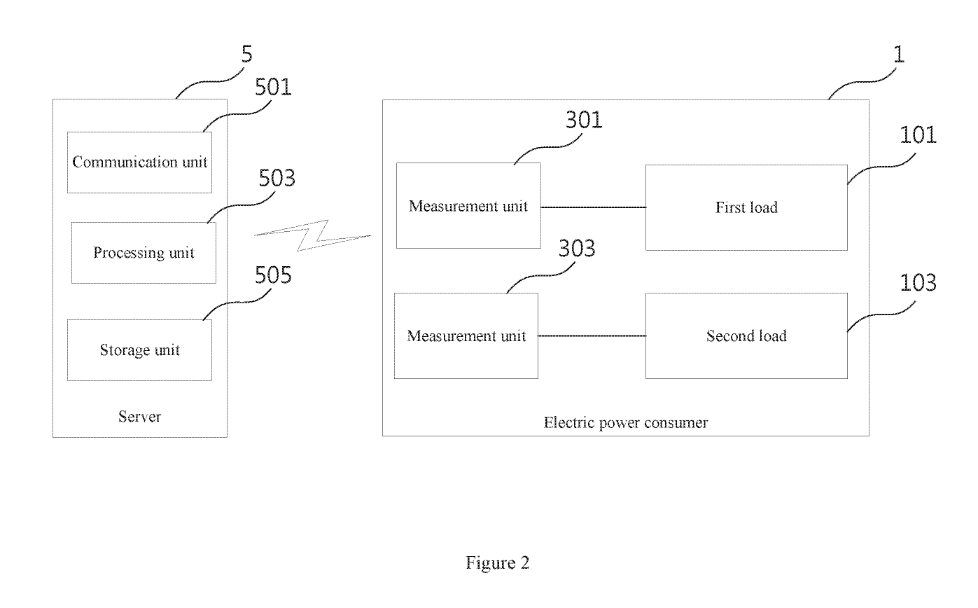

Next, the system required to achieve the method for analyzing client events of an electric power consumer according to the present invention will be described. Please refer to FIG. 2, which shows a system schematic diagram of the method for analyzing client events of an electric power consumer according to the first embodiment of the present invention. As shown in the figure, the system required for the method for analyzing client events of an electric power consumer according to the present invention comprises an electric power consumer 1, a measurement unit 301, a measurement unit 303, and a server 5. The electric power consumer 1 includes a first load 101 and a second load 103. The first measurement unit 301 is connected electrically to the first load 101; the second measurement unit 303 is connected electrically to the second load 103. The server 5 includes a communication unit 501, a processing unit 503, and a storage unit 505.

The server 5 described above can be an electronic device such as a smartphone, a personal digital assistant (PDA), a tablet computer, a notebook computer, a desktop computer, a sever host, or a workstation.

The communication unit 501 described above can communicate with the measurement units 301, 303 in a wired or wireless method.

The first and second loads 101, 103 described above can be the appliances owned by the electric power consumer 1, for example, computers, TVs, refrigerators, microwave ovens, electromagnetic ovens, or air conditioners.

The first measurement unit 301 and the second measurement unit 303 described above can measure the load operation time of the first load 101 and the second load 103. The load operation time includes the load startup time and the load shutdown time. The measured load operation time is transmitted to the server 5 in a wired or wireless method.

In the following, the flow for executing the method for analyzing client events of an electric power consumer according to the first embodiment of the present invention will be described. Please refer to FIG. 1 and FIG. 2. To analyze client events of an electric power consumer, the steps S through S7 will be executed.

In the step S1 of acquiring load information and defining client event, the server 5 acquires the load information of the first load 101 and the load information of the second load 103 of the electric power consumer 1. The first measurement unit 301 acquires the load startup time and the load shutdown time of the first load 101; the second measurement unit 303 acquires the load startup time and the load shutdown time of the second load 103. The acquired load startup time and load shutdown time will be transmitted to the server 5. In other words, the server 5 will acquire a plurality pieces of load information and the load operation time of the corresponding load of each piece of load information of the electric power consumer 1 via the communication unit 501. In addition, one or more client event is defined in the storage unit 503 of the server 5. The client event can be any possible client event of the electric power consumer 1. For example, client events can be reading events, bath events, cooking events, entertainment events, or dining events.

In the step S3 of acquiring load operation modes, the processing unit 503 of the server 5 acquires a plurality of load operation modes according the load operation time of each load. For example, when the load startup time of the first load 101 and the load startup time of the second load 103 are close and the load shutdown time of the first load 101 and the load shutdown time of the second load 103 are also close, the processing unit 503 of the server 5 acquires a load operation mode including the first and second loads 101, 103. When the electric power consumer 1 has multiple loads, the processing unit 503 of the server 5 acquires a plurality of load operation modes according the load operation time of each load.

Each load is not limited to only one of the load operation modes. Namely, as the electric power consumer 1 has the first load 101, the second load 103, and the third load, the processing unit 503 of the server 5 can acquire a load operation mode including the first and second loads 101, 103 and another load operation mode including the first load 101 and the third load according to the respective operation time of the first load 101, the second load 103, and the third load.

Furthermore, in addition to including multiple loads, each load operation mode can include only one load. That is to say, the load operation mode includes one or more load.

In the step S5 of acquiring load operation relation modes, the server 5 acquires a plurality of load operation relation modes according to the load operation modes. The processing unit 503 of the server 5 uses a probability density function to calculate the plurality of load operation modes and judge if the load operation modes are related to one another. Then the related load operation modes form a load operation relation mode. When there are multiple load operation modes, the processing unit 503 of the server 5 will acquire a plurality of load operation relation modes. The probability density function can be moments, maximum, regression of cumulative, histogram, multivariate kernel density estimation, or other probability density functions.

In the step S7 of corresponding the load operation relation modes to the client event, the processing unit 503 of the server 5 corresponds each load operation relation mode to a client event. Each client event may correspond to one or multiple load operation relation mode. For example, when a first load operation relation mode includes a first load operation mode, a second load operation mode, a second load operation relation mode including a third load operation mode and a fourth load operation mode, and a third load operation relation mode including a fifth load operation mode and a sixth load operation mode, the processing unit 503 of the server 5 can correspond the first and second load operation relation modes to a first client event and the third load operation relation mode to a second client event. The server 5 adopts the data mining or expert system method to correspond each load operation relation mode to a client event.

Up to now, the method for analyzing client events of an electric power consumer according to the first embodiment of the present invention is completed. According to the present embodiment, what load operation relation modes are included in the client events of an electric power consumer can be analyzed and the behavior model of the electric power consumer can be built. As the load operation mode of the electric power consumer is abnormal, early discovery can be made. For example, the corresponding load operation relation mode of the bath event of the electric power consumer includes starting up and shutting down the load operation mode of the electric water heater and starting up and shutting down the load operation mode of the exhaust. When the electric water heater and the exhaust are started up, the server 5 judges that the electric power consumer is undergoing the bath event. Nonetheless, after a period, if the electric power consumer has not shut down the electric water heater and the exhaust, namely, the processes of starting up and shutting down the load operation mode of the electric water heater starting up and starting up and shutting down the load operation mode of the exhaust are not finished completely, it is judged that the behavior of the electric power consumer is abnormal. For example, the member of the electric power consumer falls and is in a coma in the bathroom. Then the associated party can be notified to care by making a phone call or handle the situation. Alternatively, the behavior of the electric power consumer can be predicted.

For example, the load operation relation mode of the entertainment event of the electric power consumer includes starting up the video game host and startup up the TV. Then, when the electric power consumer starts up the video game host, the server 5 can submit an instruction for starting up the TV, and thus achieving the efficacy of smart living space.

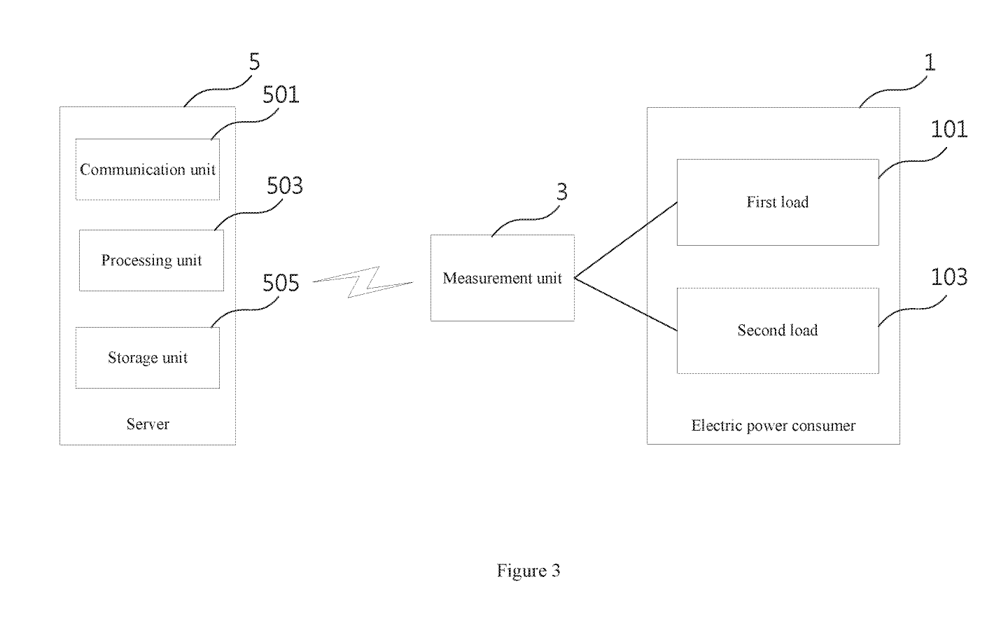

Next, the analysis of client events of an electric power consumer according to the second embodiment of the present invention will be described. Please refer to FIG. 3. The difference between the present embodiment and the first one is that, according to the present embodiment, the load detection method is noninvasive. As shown in the figure, the first and second loads 101, 103 are connected to a measurement unit 3. The communication unit 501 can communicate with the measurement unit 3 in a wired or wireless method. The measurement unit 3 can acquire the total power consumption information of the plurality of loads of the electric power consumer over a period. The server 5 acquires the total power consumption information via the communication unit 501. Then the processing unit 503 of the server 5 compares the total power consumption information using an algorithm according to the power-consuming features of each corresponding load of each piece of load information and gives the operation time of each load in the period. Alternatively, the processing unit 503 of the server 5 can give the operation probability of each load in each time segment according to the corresponding load power consumption of each piece of load information of the electric power consumer 1 and the total power consumption information of the electric power consumer 1 within a period, and further give the load operation time according to the operation probability of load. For example, when the operation probability of load in a time segment is greater than a threshold value, the processing unit 502 judges that the load is started in that time segment and sets the time segment as a load startup time of the load. When the operation probability of load in a time segment is lower than a threshold value, the processing unit 502 judges that the load is shut down in that time segment and sets the time segment as a load shutdown time of the load. The rest part is the same as that according to the first embodiment. Hence, the details will not be described again.

According to the present embodiment, the load operation condition of the electric power consumer 1 is acquired in a noninvasive load detection method. Compared with the first embodiment, the present embodiment has lower setup costs.

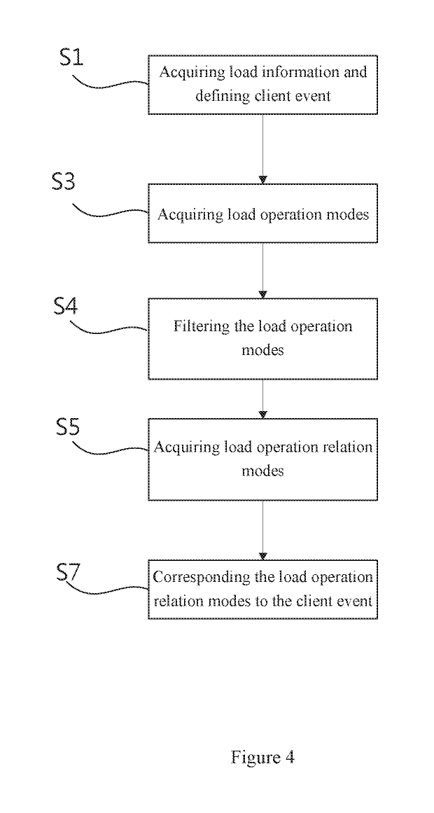

In the following, the analysis of client events of an electric power consumer according to the third embodiment of the present invention will be described. Please refer to FIG. 4. The difference between the present embodiment and the first one is that, according to the present embodiment, a step S4 is further included after the step S3 for filtering the load operation modes.

In the step S4 of filtering the load operation modes, the processing unit 503 of the server 5 uses a support algorithm to calculate the appearance frequency of each load operation mode and delete the load operation modes with an appearance frequency lower than a threshold value for giving the plurality of load operation modes. In daily living, the electric power consumer 1 may have random behaviors of starting up or shutting down the loads, for example, watching TV due to sleeplessness at midnight, making snacks impromptu, or simply turning on and off TV. These load operation modes will be recorded by the measurement unit 3 and submitted to the server 5 as well. Nonetheless, because this type of random load operation modes is relatively unable to be related to other load operation modes, or the generated load operation relation modes are unable to be corresponded to client events due to the presence of the random load operation modes, before acquiring the load operation relation modes, the support algorithm is used in advance to eliminate these random load operation modes. This facilitates higher accuracy of the acquired load operation relation modes, as well as reducing the computation time for acquiring the load operation relation modes. The support algorithm includes the apriori algorithm, the boolean-apriori algorithm, the multiple minimum support algorithm, or other support algorithms.

According to an embodiment of the present invention, in the step S4, the processing unit 503 of the server 5 uses a similarity algorithm to calculate and give a plurality of load operation modes according to a piece of location information or/and a piece of type information of each piece of load information in each load operation mode. The loads of the electric power consumer 1 own their own installation locations, such as the living room, the kitchen, or the bedroom, and load types, such as TVs being entertainment-type loads and vacuums being cleaning-type loads. In the similarity calculation, the similarity of a load operation mode and others will be calculated according to the location or/and the type of each load in the load operation modes to give a plurality of load operation modes. By means of the similarity calculations, the acquired load operation relation modes will be more accurate. The similarity algorithm includes the Bray-Curtis dissimilarity, the Morisita-Horn index, the abundance Jaccard index, the abundance Sorensen index, or other similarity algorithms.

According to an embodiment of the present invention, in the step S4, the processing unit 503 of the server 5 uses a support algorithm and a similarity algorithm to calculate and give a plurality of load operation modes for eliminating random load operation modes and acquiring the similarity among load operation modes.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A method for analyzing client events of an electric power consumer, comprising steps of:
acquiring a plurality pieces of load information of an electric power consumer, and defining one or more client event;
acquiring a plurality of load operation modes of said electric power consumer according to the respective load operation time of said plurality pieces of load information;
acquiring a plurality of load operation relation modes according to said plurality of load operation modes; and
corresponding said plurality of load operation relation modes to said one or more client event, respectively.

2. The method for analyzing client events of an electric power consumer of claim 1, and after said step of acquiring said plurality of load operation modes of said electric power consumer according to the respective load operation time of said plurality pieces of load information, further comprising a step of calculating the operation frequency of each load of each said load operation mode and giving said plurality of load operation modes using a support algorithm.

3. The method for analyzing client events of an electric power consumer of claim 1, and after said step of acquiring said plurality of load operation modes of said electric power consumer according to the respective load operation time of said plurality pieces of load information, further comprising a step of calculating to give said plurality of load operation modes according to a piece of location information of each said piece of load information or/and a piece of type information of each said piece of load information in each load operation mode using a similarity algorithm.

4. The method for analyzing client events of an electric power consumer of claim 1, and after said step of acquiring said plurality of load operation modes of said electric power consumer according to the respective load operation time of said plurality pieces of load information, further comprising a step of calculating to give said plurality of load operation modes using a support algorithm, a similarity algorithm and each said load operation mode.

5. The method for analyzing client events of an electric power consumer of claim 1, wherein said plurality of load operation relation modes are given by calculating a probability density function.

6. The method for analyzing client events of an electric power consumer of claim 1, wherein said plurality of load operation relation modes are corresponded to said one or more client event using an expert system or data mining.

7. The method for analyzing client events of an electric power consumer of claim 1, wherein said load operation time includes a load startup time and a load shutdown time.

8. A system for analyzing client events of an electric power consumer, comprising:
an electric power consumer, including a plurality of loads and a plurality of measurement units, each said load connected to one of said plurality of measurement unit, respectively, and each measurement unit acquiring a load operation time of said connected load;
a server, including a communication unit, a processing unit, and a storage unit, and said storage unit defining one or more client event;
where said server acquires a plurality pieces of load information with each piece of load information corresponding to one of said plurality of loads, respectively; said server acquires the corresponding load operation time of each said load via said communication unit; said processing unit acquires a plurality of load operation modes of said electric power consumer according to the respective load operation time of said plurality pieces of load information; and said processing unit acquires a plurality of load operation relation modes according to said plurality of load operation modes, and corresponding said plurality of load operation relation modes to said one or more client event, respectively.

9. The system for analyzing client events of an electric power consumer of claim 8, wherein said processing unit calculates the operation frequency of each load of each said load operation mode and gives said plurality of load operation modes using a support algorithm.

10. The system for analyzing client events of an electric power consumer of claim 8, wherein said processing unit calculates to give said plurality of load operation modes according to a piece of location information of each said piece of load information or/and a piece of type information of each said piece of load information in each load operation mode using a similarity algorithm.

11. The system for analyzing client events of an electric power consumer of claim 8, wherein said processing unit calculates to give said plurality of load operation modes using a support algorithm, a similarity algorithm, and each said load operation mode.

12. The system for analyzing client events of an electric power consumer of claim 8, wherein said processing unit calculates to give said plurality of load operation relation modes using a probability density function.

13. The system for analyzing client events of an electric power consumer of claim 8, wherein said processing unit corresponds said plurality of load operation relation modes to said one or more client event using an expert system or data mining.

14. The system for analyzing client events of an electric power consumer of claim 8, wherein said load operation time includes a load startup time and a load shutdown time.

15. A system for analyzing client events of an electric power consumer, comprising:
an electric power consumer, including a plurality of loads and a measurement unit, said plurality of loads connected to said measurement unit, and said measurement unit acquiring a piece of total power consumption information of said plurality of loads within a period;
a server, including a communication unit, a processing unit, and a storage unit, and said storage unit defining one or more client event;
where said server acquires a plurality pieces of load information with each piece of load information corresponding to one of said plurality of loads, respectively; said server acquires said piece of total power consumption information via said communication unit; said processing unit acquires a load operation time of each said load according to the corresponding load power consumption of each said piece of load information and said piece of total power consumption information; said processing unit acquires a plurality of load operation modes of said electric power consumer according to the respective load operation time of each said piece of load information; and said processing unit acquires a plurality of load operation relation modes according to said plurality of load operation modes, and corresponding said plurality of load operation relation modes to said one or more client event, respectively.

16. The system for analyzing client events of an electric power consumer of claim 15, wherein said processing unit calculates the operation frequency of each load of each said load operation mode and gives said plurality of support-calculated load operation modes using a support algorithm.

17. The system for analyzing client events of an electric power consumer of claim 15, wherein said processing unit calculates to give said plurality of load operation modes according to a piece of location information of each said piece of load information or/and a piece of type information of each said piece of load information in each load operation mode using a similarity algorithm.

18. The system for analyzing client events of an electric power consumer of claim 15, wherein said processing unit calculates to give said plurality of load operation modes using a support algorithm, a similarity algorithm, and each said load operation mode.

19. The system for analyzing client events of an electric power consumer of claim 15, wherein said processing unit calculates to give said plurality of load operation relation modes using a probability density function.

20. The system for analyzing client events of an electric power consumer of claim 15, wherein said processing unit corresponds said plurality of load operation relation modes to said one or more client event using an expert system or data mining.

21. The system for analyzing client events of an electric power consumer of claim 15, wherein said load operation time includes a load startup time and a load shutdown time.
